(19) United States
(12) Patent Application Publication
(10) Pub. No.: US 2024/0056931 A1
(43) Pub. Date: Feb. 15, 2024

(54) CELL MEASUREMENT METHOD AND USER EQUIPMENT

(71) Applicant: Purplevine Innovation Company Limited, Hong Kong (CN)

(72) Inventor: Yi-Ting LIN, Hong Kong (CN)

(73) Assignee: Purplevine Innovation Company Limited, Hong Kong (CN)

(21) Appl. No.: 17/910,365

(22) PCT Filed: Mar. 30, 2022
(86) PCT No.: PCT/CN2022/084168

§ 371 Date: Oct. 6, 2022

Related U.S. Application Data
(60) Provisional application No. 63/168,265, filed on Mar. 31, 2021.

(51) Int. Cl. H04W 36/30; H04W 36/00; H04W 76/19; H04W 76/20

(52) U.S. Cl. CPC H04W 36/305; H04W 36/0058; H04W 76/19; H04W 76/20

(57) ABSTRACT

A user equipment (UE) executes a cell measurement method to shorten the time from radio link failure to reconnect to a telecommunication network. The UE detects at least one of a plurality triggering events for neighbor cell measurements associated with evaluating of the signal quality of the reference signals in the narrowband downlink channel in the serving cell. The UE performs neighbor cell measurements on reference signals in a narrowband downlink channel in one or more neighbor cells in a cell measurement period in response to the at least one of a plurality triggering events. The neighbor cell measurements are performed before radio link failure (RLF) associated with the user equipment. The UE selects at least one target cell among the one or more neighbor cells through the neighbor cell measurements and performs a cell reestablishment procedure.

### BACKGROUND OF DISCLOSURE

### 1. Field of Disclosure

The present disclosure relates to the field of cellular communication, and more particularly, to a cellular communication for Narrowband Internet of Things (NB-IoT).

### 2. Description of Related Art

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

Additional enhancements to Narrowband Internet of Things (NB-IoT) and enhanced machine type communication (eMTC) are desired and have been discussed in 3GPP as a work item (WI). The work item endeavors to reduce mobility latency and enhances service continuity for NB-IoT use cases. An NB-IoT device, such as a UE, when encountering radio link failure (RLF), can lose the radio resource control (RRC) connection until obtaining one or more potential target cells through neighbor cell measurements and reestablishing an RRC connection with one of the obtained target cells. Cell searching for a suitable target cell from one or more neighbor cells is time consumptive. The RLF and lost of the RRC connection can restrict service continuity of NB-IoT devices and is not appropriate to mobile NB-IoT applications. Hence, a solution is desired to address the problem.

### SUMMARY

An object of the present disclosure is to propose a cell measurement method and a user equipment.

In a first aspect, an embodiment of the invention provides a cell measurement method executable in a user equipment (UE), comprising:

evaluating signal quality of reference signals in a narrowband downlink channel in a serving cell;
detecting at least one of a plurality triggering events for neighbor cell measurements associated with the evaluating of the signal quality of the reference signals in the narrowband downlink channel in the serving cell;
performing neighbor cell measurements on reference signals in a narrowband downlink channel in one or more neighbor cells in a cell measurement period in response to the at least one of a plurality triggering events, wherein the neighbor cell measurements are performed before radio link failure (RLF) associated with the user equipment;
selecting at least one target cell among the one or more neighbor cells through the neighbor cell measurements in the narrowband downlink channel in one or more neighbor cells; and
performing a cell reestablishment procedure with the at least one target cell when a condition for the cell reestablishment procedure is met.

In a second aspect, an embodiment of the invention provides a user equipment (UE) comprising a processor configured to call and run a computer program stored in a memory, to cause a device in which the chip is installed to execute the disclosed method and any combination of embodiments of the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

### Advantageous Effects

By performing early neighbor cell measurements before the declaration of RLF, the UE can re-establish a new connection with the target cell as early as possible.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view of a telecommunication system.

FIG. 2 illustrates a schematic view showing the disclosed method according to an embodiment of the disclosure.

FIG. 3 illustrates a schematic diagram showing a timeline of RLF and RRC re-establishment.

FIG. 4 illustrates a schematic diagram showing inter-frequency neighbor cell measurements between references points A and B.

FIG. 5 illustrates a schematic diagram showing intra-frequency neighbor cell measurements between references points A and B.

FIG. 6 illustrates a schematic diagram showing inter-frequency neighbor cell measurements between references points B and C.

FIG. 7 illustrates a schematic diagram showing intra-frequency neighbor cell measurements between references points B and C.

FIG. 8 illustrates a schematic diagram showing an embodiment of inter-frequency neighbor cell measurements between references points A and B and between references points B and C.

FIG. 9 illustrates a schematic diagram showing an embodiment of intra-frequency neighbor cell measurements between references points A and B and between references points B and C.

FIG. 10 illustrates a schematic diagram showing a portion of an embodiment of the disclosed method with a short timer to reduce link recovery time between reference points B and C.

FIG. 11 illustrates a schematic diagram showing another portion of an embodiment of the disclosed method with a short timer to reduce link recovery time between reference points B and C.

FIG. 12 illustrates a schematic diagram showing an embodiment of the disclosed method where the timer (e.g., T310 timer) for radio link recovery is not used.

FIG. 13 illustrates a schematic diagram showing an embodiment of the procedure of neighbor cell measurements independent of the procedure of RLF and RRC re-establishment.

FIG. 14 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

One of the objectives of some embodiment of the invention is to specify signaling and triggering for neighbor cell measurements before radio link failure (RLF), to reduce the time to radio resource control (RRC) reestablishment to another cell, without defining specific downlink gaps. Currently, enhancements to the random access procedure are not considered. The solution may include reduction of the time between declaration of RLF and the start of the random access procedure.

An embodiment of the invention describes how to trigger a UE to perform neighbor cell measurements between declaration of radio link failure (RLF) and the start of the random access procedure. An embodiment of the invention describes how to configure the UE to perform neighbor cell measurements based on discontinuous reception (DRX) configurations.

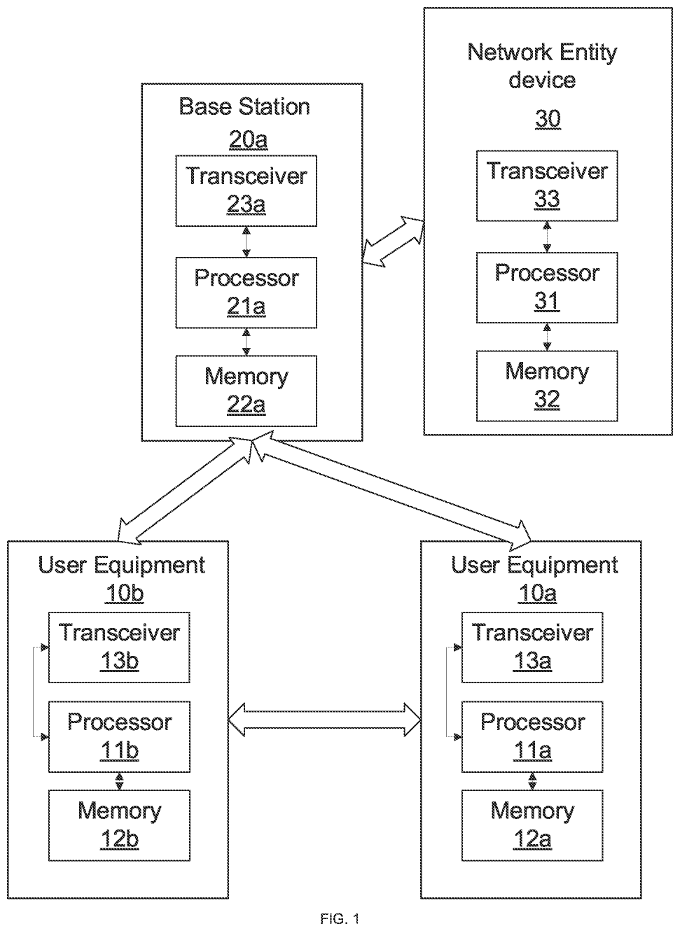

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative, not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

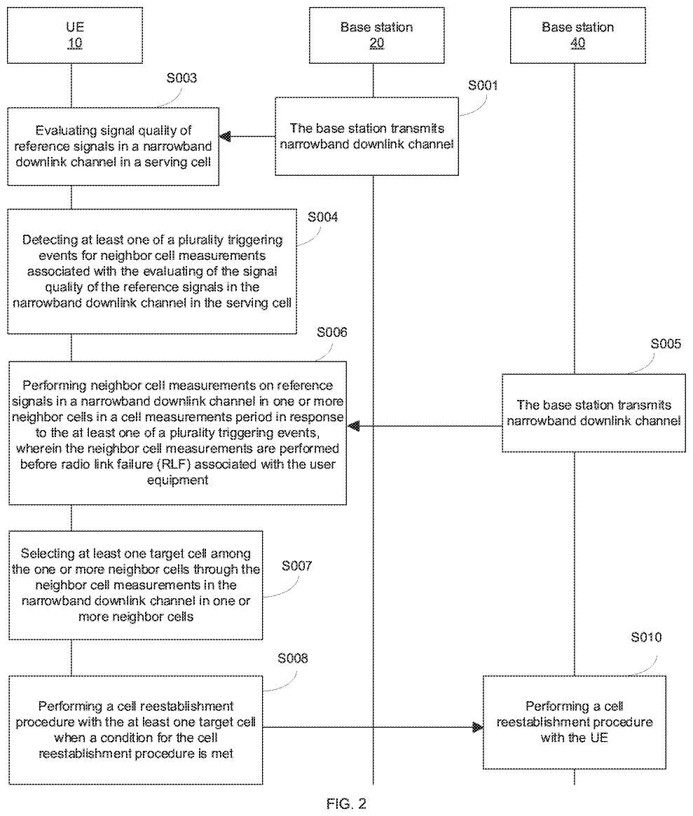

With reference to FIG. 2, a UE 10 executes a cell measurement method with a base station 20 and one more neighbor cells including base station 40. Each of the base stations 20 and 40 may comprise an embodiment of the base station 20a. Note that although the base stations 20 and 40 are described as examples in the description, the cell measurement method may be executed by other types of base station, such as another gNB, an eNB, a base station integrating an eNB and a gNB, or a base station for beyond 5G technologies. The UE 10 may comprise an embodiment of the UE 10a or UE 10b.

The base station 20 transmits narrowband downlink channel to the UE 10 (S001). The UE 10 evaluates signal quality of reference signals in a narrowband downlink channel in a serving cell (S003). In the embodiment, the base station 20 provides the serving cell. In some embodiments, the signal quality of the reference signals in the narrowband downlink channel in the serving cell is measured based on reference signal received power (RSRP) or reference signal received quality (RSRQ). The narrowband downlink channel in the serving cell comprises narrowband physical downlink shared channel (NPDSCH), narrowband physical downlink control channel (NPDCCH), primary/secondary synchronization signal (PSS/SSS), and/or reference signals for radio link monitoring. The evaluating of the signal quality of the reference signals in the narrowband downlink channel in the serving cell comprises determining whether the signal quality of the reference signals in the narrowband downlink channel in the serving cell is lower than a signal quality threshold. The signal quality threshold may be configured by a broadcast message SystemInformationBlockType3-NB, a unicast message RRCConnectionReconfiguration-NB, or a unicast message RRCConnectionResume-NB.

The UE 10 detects at least one of a plurality triggering events for neighbor cell measurements associated with the evaluating of the signal quality of the reference signals in the narrowband downlink channel in the serving cell (S004). The at least one of a plurality triggering events may comprises: a condition that at least one out-of-sync indication is received from a physical layer of the UE; or a condition that the signal quality of the reference signals in the narrowband downlink channel in the serving cell is greater lower than a signal quality threshold.

The base station 40 transmits narrowband downlink channel to the UE 10 (S005). The UE 10 performs neighbor cell measurements on reference signals in a narrowband downlink channel in one or more neighbor cells in a cell measurement period in response to the at least one of a plurality triggering events, wherein the neighbor cell measurements are performed before radio link failure (RLF) associated with the user equipment (S006). In the embodiment, the base station 40 provides at least one neighbor cell in the one or more neighbor cells. The narrowband downlink channel in the one or more neighbor cells comprises a narrowband physical downlink shared channel (NPDSCH) or a narrowband physical downlink control channel (NPDCCH). The cell measurement period comprises one or more of a connected mode discontinuous reception (CDRX) off period or a downlink gap. The neighbor cell measurements may comprise intra-frequency neighbor cell measurements or inter-frequency neighbor cell measurements. The neighbor cell measurements may be performed after a T310 timer starts and before expiry of the T310 timer.

The UE 10 selects at least one target cell among the one or more neighbor cells through the neighbor cell measurements in the narrowband downlink channel in one or more neighbor cells (S007).

The UE 10 performs a cell reestablishment procedure with the at least one target cell when a condition for the cell reestablishment procedure is met (S008). In the embodiment, the base station 40 performs a cell reestablishment procedure with the UE 10 (S010). In an embodiment, the condition for cell reestablishment procedure with the at least one target cell comprises expiry of a T310 timer. The cell reestablishment procedure with the at least one target cell is performed in response to expiry of the T310 timer.

In the following description, unless elsewhere specified, a UE can be interpreted as an embodiment of the UE 10. A monitored link or radio link may be a narrowband downlink channel in a serving cell. The narrowband downlink channel may comprise a narrowband physical downlink shared channel (NPDSCH) or a narrowband physical downlink control channel (NPDCCH).

T310 timer is defined in 3GPP technical specification (TS) 36.331 version 16.0.0. A portion of the definition of T310 timer is given in the following:

TABLE 1

| Timer | Start | Stop | At expiry |
|---|---|---|---|
| T310 | Upon detecting physical | Upon receiving N311 | If security is not |
| | layer problems for the | consecutive in-sync | activated and the UE is |
| | PCell i.e., upon | indications from lower | not a NB-IoT UE that |
| | receiving N310 | layers for the PCell, | supports RRC |
| | consecutive out-of-sync | upon triggering the | connection |
| | indications from lower | handover procedure, | reestablishment for the |
| | layers. | upon initiating the | Control Plane CIoT |
| | | connection re- | EPS/5GS optimisation: |
| | | establishment | go to RRC_IDLE else: |
| | | procedure, and upon | initiate the MCG failure |
| | | initiating the MCG | information procedure |
| | | failure information | as specified in 5.6.26 or |
| | | procedure. | the connection re- |
| | | | establishment |
| | | | procedure as specified |
| | | | in 5.3.7 |

Constants N310 and N311 are defined in 3GPP technical specification (TS) 36.331 version 16.0.0. A portion of the definition of N310 and N311 is given in the following:

TABLE 2

| Constant | Usage |
|---|---|
| N310 | Maximum number of consecutive “out-of-sync” or “early-out- |
| | of-sync” indications for the PCell received from lower layers |
| N311 | Maximum number of consecutive “in-sync” or “early-in-sync” |
| | indications for the PCell received from lower layers |

A serving cell of a UE is a cell that serves the UE. For a UE in a radio resource control (RRC) connected state (i.e., RRC_CONNECTED) not configured with carrier aggregation (CA) there is only one serving cell comprising of the primary cell (PCell). For a UE in RRC_CONNECTED configured with CA, the term ‘serving cells’ is used to denote the set of one or more cells comprising of the primary cell and all secondary cells (SCells).

A primary cell (PCell) is a cell operating on the primary frequency, in which the UE either performs the initial connection establishment procedure or initiates the connection re-establishment procedure, or the cell indicated as the primary cell in the handover procedure.

A secondary cell (SCell) is a cell operating on a secondary frequency, which may be configured once an RRC connection is established and which may be used to provide additional radio resources to the UE.

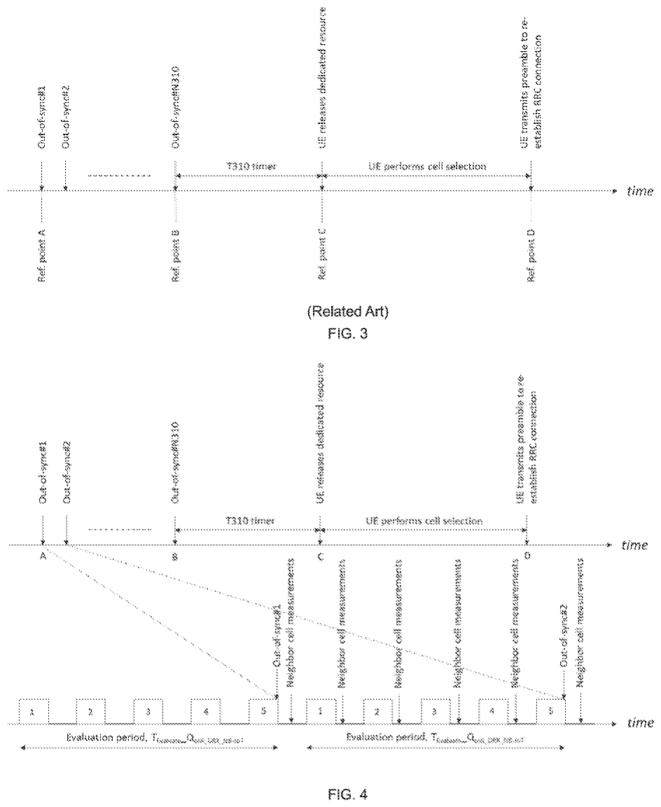

For NB-IoT mobility in an RRC connected mode, a UE-based RRC re-establishment procedure (i.e., a UE breaks and then makes new connection) was adopted. To save power, a UE does not periodically perform neighbor cell measurements and use cell selection instead to find a new cell after a connection is broken. Currently, an NB-IoT UE has no cell measurement, measurement report, or handover procedure. FIG. 3 illustrates a schematic diagram showing a timeline of RLF and RRC re-establishment.

At reference point A, a UE stays in RRC connected state and receives out-of-sync indication from a physical layer of the UE for the primary cell (PCell) when the UE detects that the downlink link quality for the PCell obtained from the cell-specific reference signal is lower than the threshold Qₒᵤₜ. An out-of-sync indication is provided from a physical layer (known as L1 lay or PHY layer) of a UE to an upper layer of the UE and can be referred to as out-of-sync. An in-sync indication is provided from the physical layer of a UE to an upper layer of the UE and can be referred to as in-sync. After receiving N310 consecutive out-of-sync indications, the UE starts T310 timer at reference point B. Until T310 timer expires, the UE will stay in RRC connected state when receiving N311 consecutive in-sync indications from the physical layer. When T310 timer expires, the UE will release dedicated radio resource and go to RRC idle state. At reference point C, the UE performs cell selection to find a suitable cell such that the UE can connect to the cell for data transmission. When locating a new cell as a suitable cell, the UE initiates a random access procedure and an RRC re-establishment procedure at reference point D to re-establish an RRC connection with the new cell. The total time between reference point A and D is analyzed in the following:
Between A and B: Within this interval, data transmission is still possible, but the downlink radio link may have up to 10% block error rate during physical downlink control channel (PDCCH) transmission and cannot be reliably received. Based on the requirements in section 7.6.2.1 in 3GPP TS 36.133, the interval between each out-of-sync indication is at least 200 milliseconds (ms) when no discontinuous reception (DRX) is used. When connected DRX is configured (i.e., DRX cycle 2.56 seconds), the interval depends on the DRX cycle and ranges from 200 ms to 12.8 seconds (i.e., 5 DRX cycles of 2.56 seconds). When enhanced DRX (eDRX) is configured (i.e., 2.56 seconds <eDRX cycle 10.24 seconds), the interval can be up to 51.2 seconds (i.e., 5 eDRX cycles of 10.24 seconds). The number of N310 can be configured as 1, 2, 3, 4, 6, 8, 10, and 20, which is defined in RLF-TimersAndConstants-NB information element (IE) in 3GPP TS 36.331. Therefore, the time between reference point A and B can be from 200 ms to 1024 seconds.
Between B and C: Within this interval, data transmission is still possible, but the downlink radio link may have up to 10% block error rate of during PDCCH transmission and cannot be reliably received. Based on RLF-TimersAndConstants-NB information element in 3GPP TS 36.331, the T310 timer (represented by variable t310-r13) can be configured from 0 to 8000 ms.
Between C and D: Within this interval, connection interruption happens and there is no data transmission. Based on RLF-TimersAndConstants-NB information element in 3GPP TS 36.331, the T311 timer is used to control the RRC re-establishment and can be configured from 0 to 200000 ms (i.e., 200 seconds).

Because of the high block error rate, the time of connection interruption can be extended from reference point A to D and the total interruption time can be up to 1232 seconds (i.e., 1024 of interval from A to B+8 of interval from B to C+200 of interval from C to D) which has a significant impact on data transmission.

The interruption time is too long to sustain continuity during data transmission, and user experience is significantly impacted. Although most of the use cases for NB-IoT are delay tolerant, some applications (e.g., shared bikes, wearable devices, and equipment tracking) still need to complete the data transmission as early as possible.

Currently, UE can perform neighbor cell measurements in RRC connected mode. However, no specific measurement gap is defined for the neighbor cell measurements. Without measurement gap, the eNB may schedule downlink resources for the UE during neighbor cell measurements at the UE. As a consequence, the downlink resources will be lost.

The solution for reducing interruption time may include reduction of the time between reference points C and D. The requirements of RRC re-establishment delay (i.e., the time required between reference points C and D) is defined in section 6.5.2.1 of 3GPP TS 36.133, some of which are shown in the following.

```
TABLE 3
6.5.2.1 UE Re-establishment delay requirement in normal coverage
The UE re-establishment delay (T_{UE}_{_{—}}_{re-establish}_{_{—}}_{delay}_{_{—}}_{NB-IoT}) is the time between the moments when any
of the conditions requiring RRC re-establishment as defined in clause 5.3.7 in TS 36.331 is detected by
the UE to the time when the UE sends PRACH preamble to the target cell. The UE re-establishment
delay (T_{UE}_{_{—}}_{re-establish}_{_{—}}_{delay}_{_{—}}_{NB-IoT}) requirement shall be less than:
T_{UE-re-establish}_{_{—}}_{delay}_{_{—}}_{NB-IoT} = 100 ms + N_{NB-Iot-freq} *T_{search}_{_{—}}_{NB1-NC} + T_{SI}_{_{—}}_{NB1-NC} + T_{PRACH}_{_{—}}_{NB-IoT};
  T_{search}_{_{—}}_{NB1-NC}: It is the time required by the UE to search the target cell:
    If the target cell is known, then T_{search}_{_{—}}_{NB1-NC} = 0 ms. If the target cell is unknown and signal
    quality is sufficient for successful cell detection on the first attempt, then T_{search}_{_{—}}_{NB1-NC} = 80 ms.
    Otherwise, T_{search}_{_{—}}_{NB1-NC} = 1400 ms.
  T_{SI}_{_{—}}_{NB1-NC}: It is the time required for receiving all the relevant system information according to the
  reception procedure and the RRC procedure delay of system information blocks defined in TS
  36.331 for the target cell for a UE in normal coverage.
  T_{PRACH}_{_{—}}_{NB-IoT}: The additional delay caused by the random access procedure. The actual value of
  T_{PRACH}_{_{—}}_{NB-IoT} shall depend upon the NPRACH configuration used in the target cell and the number
  of repetitions used by UE for sending random access to the target cell. There might be additional
  delay due to ramping procedure.
  N_{NB-Iot-freq}: It is the total number of NB-IoT frequencies to be monitored for RRC re-establishment;
  N_{NB-Iot-freq} = 1 if the target cell is known.
There is no requirement if the target cell does not contain the UE context.
```

TABLE 4
6.5.2.2 UE Re-establishment delay requirement in enhanced coverage
The UE re-establishment delay (T_{UE}_{_{—}}_{re-establish}_{_{—}}_{delay}_{_{—}}_{NB-IoT}) is the time between the moments when any
of the conditions requiring RRC re-establishment as defined in clause 5.3.7 in TS 36.331 is detected by
the UE to the time when the UE sends PRACH preamble to the target cell. The UE re-establishment
delay (T_{UE}_{_{—}}_{re-establish}_{_{—}}_{delay}_{_{—}}_{NB-IoT}) requirement shall be less than:
T_{UE-re-establish}_{_{—}}_{delay}_{_{—}}_{NB-IoT} = 100 ms + N_{NB-Iot-freq}*T_{search}_{_{—}}_{NB1-EC} + T_{SI}_{_{—}}_{NB1-EC} + T_{PRACH}_{_{—}}_{NB-IoT}

| - | T_{search}_{_{—}}_{NB1-EC}: It is the time required by the UE to search the target cell: | |
|---|---|---|
| | - | If the target cell is known, then T_{search}_{_{—}}_{NB1-EC} = 0 ms. If the target cell is unknown and signal |
| | | quality is sufficient for successful cell detection on the first attempt, then T_{search}_{_{—}}_{NB1-EC} = 80 ms. |
| | | Otherwise, T_{search}_{_{—}}_{NB1-EC} = 14800 ms. |

| | |
|---|---|
| - | T_{SI}_{_{—}}_{NB1-EC}: It is the time required for receiving all the relevant system information according to the |
| | reception procedure and the RRC procedure delay of system information blocks defined in TS |
| | 36.331 for the target cell for a UE in enhanced coverage. |
| - | T_{PRACH}_{_{—}}_{NB-IoT}: The additional delay caused by the random access procedure. The actual value of |
| | T_{PRACH}_{_{—}}_{NB-IoT} shall depend upon the NPRACH configuration used in the target cell and the number |
| | of repetitions used by UE for sending random access to the target cell. There might be additional |
| | delay due to ramping procedure. |
| - | N_{NB-Iot-freq}: It is the total number of NB-IoT frequencies to be monitored for RRC re-establishment; |
| | N_{NB-Iot-freq} = 1 if the target cell is known. |

There is no requirement if the target cell does not contain the UE context.

PRACH stands for physical random access channel (PRACH). NPRACH stands for narrowband physical random access channel (NPRACH).

It shows that the re-establishment delay depends on the time required to search the target cell (i.e., to find the Narrowband Primary Synchronization Signal (NPSS) or Narrowband Secondary Synchronization Signal (NSSS) of the target cell) and the number of NB-IoT frequencies. If the target cell is known, then T_{search_NB1-NC}=0 ms. If the target cell is unknown, then T_{search_NB1-NC}=80 ms in condition where signal quality of the target cell is good, otherwise, T_{search_NB1-NC} can be up to 14800 ms when the UE is in enhanced coverage. Based on the definition in section 6.1.2.1, the target cell is known if it has been measured by the UE in the last 5 seconds. It implies that the UE should perform early neighbor cell measurements (i.e., including cell detection and system information receiving) such that the T_{search_NB1-NC} can be reduced to 0 ms and T_{SI_NB1-NC} can be reduced. Early neighbor cell measurements means that the UE performs neighbor cell measurements before starting re-establishment procedure (i.e., before reference point C).

Before reference point C, the UE is in RRC connected state. In the RRC connected state, the UE must monitor the downlink control signal every subframe to make sure if there is any data for the UE except DRX or downlink gap is configured for the UE. NPDSCH stands for narrowband physical downlink shared channel (NPDSCH). The UE can perform measurements during DRX off period(s) or downlink gap(s) without monitoring the serving cell. A DRX off period is a period which is not the on period in a DRX cycle. Therefore, to perform early neighbor cell measurements, the UE should be configured with connected mode DRX (CDRX) or downlink gap such that the UE can perform neighbor cell measurements.

Embodiments of the invention address how to trigger the UE to perform early neighbor cell measurements during CDRX off period between reference point B and C. An embodiment of the invention describes the procedure about how to configure the UE to perform early neighbor cell measurements based on DRX configurations.

### 1. Trigger and Stop of Neighbor Cell Measurements

Based on the requirement of radio link monitoring for Category NB1 (e.g., a definition in section 7.23 in TS 36.133), the UE shall monitor the link continuously upon initiation of the T310 timer and until the expiry or stop of the timer. That is, when T310 timer starts, the UE should seek to return to the serving cell again as soon as possible. The UE monitors the radio link of serving cell according to an evaluation period (i.e., configured by t310-r13 in RLF-TimersAndConstants-NB information element in TS 36.331) and Layer 1 indication interval corresponding to a non-DRX mode. For the non-DRX mode, two successive indications from Layer 1 shall be separated by at least 10 ms. No upper limit of successive Layer 1 indications is set, which means CDRX can be configured during the T310 timer. (i.e., between reference points B and C). RLF-TimersAndConstants-NB information element is shown in the following:

TABLE 5
RLF-TimersAndConstants-NB information element

-- ASN1START

| | |
|---|---|
| RLF-TimersAndConstants-NB-r13 ::= | CHOICE { |
| release | NULL, |
| setup | SEQUENCE { |
| t301-r13 | ENUMERATED { |
| | ms2500, ms4000, ms6000, ms10000, |
| | ms15000, ms25000, ms40000, ms60000}, |
| t310-r13 | ENUMERATED { |
| | ms0, ms200, ms500, ms1000, ms2000, ms4000, ms8000}, |
| n310-r13 | ENUMERATED { |
| | n1, n2, n3, n4, n6, n8, n10, n20}, |
| t311-r13 | ENUMERATED { |
| | ms1000, ms3000, ms5000, ms10000, ms15000, |
| | ms20000, ms30000}, |
| n311-r13 | ENUMERATED { |
| | n1, n2, n3, n4, n5, n6, n8, n10}, |

...,

| | |
|---|---|
| t311-v1350 | ENUMERATED { |
| | ms40000, ms60000, ms90000, ms120000} |
| | OPTIONAL -- Need OR |

,

| | |
|---|---|
| t301-v1530 | ENUMERATED { |
| | ms80000, ms100000, ms120000} |
| | OPTIONAL, -- Cond TDD |
| t311-v1530 | ENUMERATED { |
| | ms160000, ms200000} |
| | OPTIONAL -- Cond TDD |

}
}
-- ASN1STOP

T310 timer represented by variable t310-r13. N310 is represented by parameter n310-r13, and N311 is represented by n311-r13.

a. Neighbor Cell Measurements Between Reference Points A and B:

### a.1 Inter-Frequency Neighbor Cell Measurements:

FIG. 4 shows an example of DRX configuration for inter-frequency neighbor cell measurements between reference points A and B. When the downlink radio link quality of the NB-IoT cell estimated over the last T_{Evaluate_Qout_DRX_NB-IoT} period becomes worse than the threshold Q_{out_NB-IoT}, Layer 1 of the UE shall send an out-of-sync indication for the NB-IoT cell to the higher layers within T_{Evaluate_Qout_DRX_NB-IoT} evaluation period. The evaluation period, T_{Evaluate_Qout_DRX_NB-IoT}, depends on the length of the DRX cycle in use. When the center frequency of a neighbor cell is different from the center frequency of anchor carrier in a serving cell of the UE, the UE needs to change its receiver center frequency to perform neighbor cell measurements. Anchor carrier is a term equivalent to PCell, typically used in the field of NB-IoT. The UE in RRC connected state may need downlink gaps for neighbor cell measurements. The DRX off period provides the opportunities of receiver downlink gap to perform inter-frequency neighbor cell measurements, and the UE can continue to receive or transmit on dedicated channels after changing back to the center frequency of the serving cell. The UE may use threshold Q_{out_NB-IoT} when receiving out-of-sync indication(s) and use threshold Q_{in_NB-IoT} when receiving in-sync indication(s). The threshold Q_{in_NB-IoT} can have a value greater than the threshold Q_{out_NB-IoT} to avoid frequent switching back and forth between out-of-sync and in-sync. Alternatively, the threshold Q_{in_NB-IoT} can have a value equal to the threshold Q_{out_NB-IoT}.

The triggering mechanism for the inter-frequency neighbor cell measurements may include one or more of a triggering event based on a number of out-of-sync indications, a triggering event based on reference signal receiving power (RSRP)/reference signal receiving quality (RSRQ) of the anchor carrier of the serving cell, and a triggering event based on a network assistance indication.
1 After a few number of out-of-sync indications: For early measurement of neighbor cell, the number of out-of-sync indications (e.g., 1) that triggers the inter-frequency neighbor cell measurements may be smaller than or equal to the number of out-of-sync indications that triggers the radio link failure.
2 Reference Signal Receiving Power (RSRP)/Reference Signal Receiving Quality (RSRQ) of the anchor carrier of the serving cell: When the RSRP/RSRQ measured over the past DRX cycles is worse than a threshold referred to as an RSRP/RSRQ threshold or a signal quality threshold, the inter-frequency neighbor cell measurements are started in the off period of the next DRX cycle.
   Note that the signal quality threshold comprises a signal quality threshold for inter-frequency neighbor cell measurements in RRC connected state and a signal quality threshold for inter-frequency neighbor cell measurements in RRC idle state. The signal quality threshold for inter-frequency neighbor cell measurements in RRC connected state is different from the signal quality threshold for inter-frequency neighbor cell measurements in RRC idle state. In an embodiment, the RSRP/RSRQ threshold for inter-frequency neighbor cell measurements in RRC connected state may be different from the RSRP/RSRQ threshold for inter-frequency neighbor cell measurements in RRC idle state. To early trigger the inter-frequency neighbor cell measurements for a UE in RRC connected state, the RSRP/RSRP threshold for RRC connected state may be lower than the one for RRC idle state.

Note that in an embodiment, the RSRP/RSRQ threshold for inter-frequency neighbor cell measurements in RRC connected state may be configured by a broadcast message (e.g., SystemInformationBlockType3-NB, SIB3-NB) or by a unicast message (e.g., RRCConnectionReconfiguration-NB or RRCConnectionResume-NB).

Note that the signal quality threshold comprises a signal quality threshold for a stationary user equipment and a signal quality threshold for a moving user equipment. The signal quality threshold for a moving user equipment is less than the signal quality threshold for a stationary user equipment. In an embodiment, the RSRP/RSRQ threshold for a stationary UE may be different from the RSRP/RSRQ threshold for a moving UE. A UE may be configured with a RSRP/RSRQ threshold for a condition in which the UE is stationary and a RSRP/RSRQ threshold for a condition in which the UE is moving. To early trigger the inter-frequency neighbor cell measurements for a moving UE, the RSRP/RSRP threshold for a moving UE may be lower than the one for a stationary UE. The UE may determine whether the UE is moving based on the variance of the measured RSRP/RSRQ at the UE. Similar concept as the relaxed monitoring criterion (Srxlev_{Ref}−Srxlev)<S_{SearchDeltaP} for a UE in RRC idle state may be adopted for determining whether a UE in RRC connected state is moving. The Srxlev is the measured value (e.g., in units of dB) of a signal reception (RX) level of the anchor carrier of the serving cell. Srxlev_{Ref} is reference Srxlev value of the anchor carrier of the serving cell. S_{SearchDeltaP} specifies the Srxlev delta threshold (in dB) during relaxed monitoring. Srxlev_{Ref} and S_{SearchDeltaP} may be configured by a broadcast message (e.g., SystemInformationBlockType3-NB, SIB3-NB) or by a unicast message (e.g., RRCConnectionReconfiguration-NB or RRCConnectionResume-NB) after the UE enters RRC connected state. Srxlev_{Ref} and S_{SearchDeltaP} for a UE in RRC connected state may be different from the ones for a UE in RRC idle state. When (Srxlev_{Ref}−Srxlev)<S_{SearchDeltaP}, the UE determines the UE itself is stationary and then adopts the RSRP/RSRQ threshold for a stationary UE to trigger the inter-frequency neighbor cell measurements. Otherwise, the UE determines the UE itself is moving and then adopts the RSRP/RSRQ threshold for a moving UE to trigger the inter-frequency neighbor cell measurements.

Note that in an embodiment, when the UE is stationary, the UE may avoid performing the inter-frequency neighbor cell measurements in RRC connected state. When the UE is moving, the UE may perform the inter-frequency neighbor cell measurements in RRC connected state based on the RSRP/RSRP threshold for a moving UE.
3 Network assistance indication: For applications such as IoT over Non-Terrestrial Networks (NTN), the network (e.g., an entity in RAN or CN) can send trigger conditions in advance to the UE in the DRX on period, and the UE performs the inter-frequency neighbor cell measurements in the DRX off period when the trigger conditions are met.

The trigger conditions may include one or more of:
a) a distance between the UE and the serving cell or a distance between the UE and the target cell;
b) a timer to time a period according to which the inter-frequency neighbor cell measurements are triggered;
c) a timing advance value to the target cell; and
d) an elevation angle of the serving cell (i.e., a source cell) and/or an elevation angle of the target cells.
   Occasions in which the UE Stop the Inter-Frequency Neighbor Cell Measurements:

When successfully detecting a neighbor cell through inter-frequency neighbor cell measurements, the UE can stop the measurements based on the S-criterion for cell selection (i.e., Srxlev>0 and Squal >0). Definition of S-criterion can be found in TS 36.304. Thus, the UE can find a suitable cell to camp on and finish data transmission. If DRX off period is still sufficient to provides opportunities exceeding a time interval (e.g., 5 seconds), the UE can continuously monitor neighbor cell(s) to make sure the neighbor cell is still a suitable cell. The UE can also detect other neighbor cells to find a most suitable cell based on R-criterion for cell reselection. Definitions of S-criterion and R-criterion can be referenced to in TS 36.304. If more neighbor cells can be detected, the UE can have more opportunities to re-establish a new connection with the next target cell to finish data transmission at the cost of consuming more power on measuring multiple neighbor cells. Whether to execute cell-selection-based measurement or cell-reselection-based measurements depends on the UE's application. If the UE is stationary or low mobility, cell-selection-based measurement can be enough. If the UE is moving fast (e.g., faster than 30 km/hr), cell-reselection-based measurement may be better.

### Analyzing Duration of DRX Off Period:

For example, in a case for coverage level 0, DRX cycle=2048 ms, onDurationTimer=pp4, Rₘₐₓ=1, and G=32, a DRX off period can be obtained according to the following formula:

DRX off period=DRX cycle−onDurationTimer=2048−pp4=2048−4*T_{NPDCCH}=2048−4*Rₘₐₓ*G=2048−41*32=1920 ms.

For coverage level 1, DRX cycle=4096 ms, onDurationTimer=pp8, Rₘₐₓ=64, and G=1.5, a DRX off period can be obtained according to the following formula:

DRX off period=DRX cycle−onDurationTimer=4096−pp8=4096−8*T_{NPDCCH}=4096−8*Rₘₐₓ*G=4096−8*64*1.5=3328 ms.

For coverage level 2, DRX cycle=8192 ms, onDurationTimer=pp16, Rₘₐₓ=256, and G=1.5, a DRX off period can be obtained according to the following formula:

DRX off period=DRX cycle−onDurationTimer=8192−pp16=8192−16*T_{NPDCCH}=8192−16*Rₘₐₓ*G=8192−16*256*1.5=2048 ms.

NPDCCH stands for narrowband physical downlink control channel (NPDCCH). MAC-MainConfig-NB information element is shown in the following:

TABLE 6
MAC-MainConfig-NB information element

| | |
|---|---|
| DRX-Config-NB-r13 ::= | CHOICE { |
| release | NULL, |
| setup | SEQUENCE { |
| onDurationTimer-r13 | ENUMERATED { |
| | pp1, pp2, pp3, pp4, pp8, pp16, pp32, spare}, |
| drx-InactivityTimer-r13 | ENUMERATED { |
| | pp0, pp1, pp2, pp3, pp4, pp8, pp16, pp32}, |
| drx-RetransmissionTimer-r13 | ENUMERATED { |
| | pp0, pp1, pp2, pp4, pp6, pp8, pp16, pp24, |
| | pp33, spare7, spare6, spare5, |
| | spare4, spare3, spare2, spare1}, |
| drx-Cycle-r13 | ENUMERATED { |
| | sf256, sf512, sf1024, sf1536, sf2048, sf3072, |
| | sf4096, sf4608, sf6144, sf7680, sf8192, sf9216, |
| | spare4, spare3, spare2, spare1}, |
| drx-StartOffset-r13 | INTEGER (0..255), |
| drx-ULRetransmissionTimer-r13 | ENUMERATED { |
| | pp0, pp1, pp2, pp4, pp6, pp8, pp16, pp24, |
| | pp33, pp40, pp64, pp80, pp96, |
| | pp112, pp128, pp160, pp320} |

}
}

### Analyzing Cell Detection Time:

Based on requirements in section 6.5.2.1/6.5.2.2 in TS 36.133, the cell detection time, T_{search_NB1-NC}, (i.e., the time to search NPSS/NSSS of the target cell) in normal coverage (i.e., coverage level 0) can be 0 if the target cell is known, or 80 ms if the target is unknown and signal quality is good, or 1400 ms if the target is unknown and signal quality is bad. The cell detection time in enhanced coverage (i.e., coverage level 1 or 2), T_{search_NB1-NC}, can be 0 if the target cell is known, or 80 ms if the target is unknown and signal quality is good, or 14800 ms if the target is unknown and signal quality is bad.

### Analysis Results for CDRX Configurations for Neighbor Cell Detection:

By appropriately configuring the DRX cycles, the DRX off period can satisfy the inter-frequency neighbor cell detection (i.e., it is different from the neighbor cell measurements) for all scenarios of normal coverage. The UE can obtain a physical cell identifier (ID) of a neighbor cell through the inter-frequency neighbor cell detection while UE can obtain signal quality (e.g., RSRP or RSRQ) of a neighbor cell through the inter-frequency neighbor cell measurements. When the UE is in the enhanced coverage, the inter-frequency neighbor cell detection may be performed in multiple DRX off periods. The worst case (i.e., 14800 ms) may be finished in 5 DRX cycles which is also the minimum requirement for detecting out-of-sync.

### a.2 Intra-Frequency Neighbor Cell Measurements:

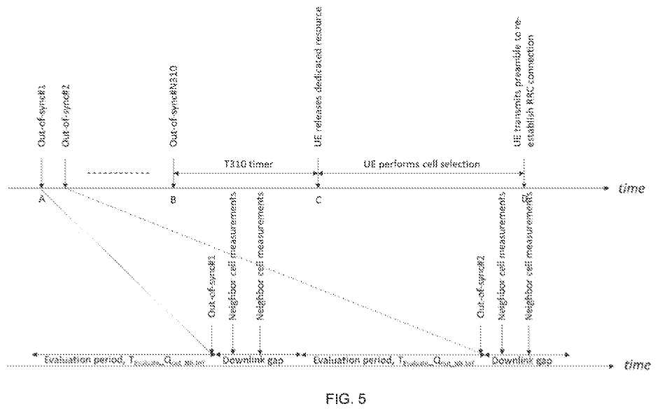

FIG. 5 shows an example of downlink gap configuration for intra-frequency neighbor cell measurements between references points A and B. When the downlink radio link quality of an NB-IoT cell estimated over the last T_{Evaluate_}Q_{out_NB-Iot} period becomes worse than the threshold Q_{out_NB-IoT}, Layer 1 of the UE shall send an out-of-sync indication for the NB-IoT cell to the higher layers of the UE within T_{Evaluate_}Q_{out_NB-Iot} evaluation period. The evaluation period, T_{Evaluate_}Q_{out_NB-Iot}, depends on the maximum NPDCCH repetitions, Rₘₐₓ. When Rₘₐₓ is smaller than or equal to 64, T_{Evaluate_}Q_{out_NB-Iot} is 400 ms. Otherwise, T_{Evaluate_}Q_{out_NB-Iot} is 4000 ms. When the center frequency of the neighbor cell is the same as the center frequency of a carrier of the serving cell, the UE does not need to change its receiver center frequency to perform neighbor cell measurements. The UE may not need long downlink gaps such as DRX off period while it is in RRC connected state. However, the UE still needs a duration of time to perform the neighbor cell measurements. The UE may perform the measurements during the downlink gap which is defined in DL-GapConfig-NB information element (in section 6.7.3 of TS 36.331) in the following:

TABLE 7
DL-GapConfig-NB information element

-- ASN1START

| | |
|---|---|
| DL-GapConfig-NB-r13 ::= | SEQUENCE { |
| dl-GapThreshold-r13 | ENUMERATED {n32, n64, n128, n256}, |
| dl-GapPeriodicity-r13 | ENUMERATED {sf64, sf128, sf256, sf512}, |
| dl-GapDurationCoeff-r13 | ENUMERATED {oneEighth, oneFourth, threeEighth, oneHalf} |

}

| | |
|---|---|
| DL-GapConfig-NB-v1530 ::= | SEQUENCE { |
| dl-GapPeriodicity-v1530 | ENUMERATED {sf1024} |

}
-- ASN1STOP

Where the downlink gap duration (in units of subframe)=dl-GapPeriodicity*dl-GapDurationCoeff. For example, the threshold on the maximum number of repetitions (i.e., Rₘₐₓ), dl-Threshold, is configured as n32 (i.e., 32 repetitions). The dl-GapPeriodicity is configured as 64 subframes, and the dl-GapDurationCoeff is configured as ⅛. When the Rₘₐₓ=64 (i.e., which is larger than the threshold 32), there are 8 subframes (i.e., 64*⅛) downlink gap duration after 64 ms NPDSCH transmissions. When T_{Evaluate_}Q_{out_NB-Iot} is configured as 400 ms, there are 40 ms downlink gap (i.e. └400/(64+8)┘*8 ms) which can be used for intra-frequency neighbor cell measurements. Such downlink gap duration may not satisfy the cell detection requirement (i.e., at least 80 ms) when the target cell is unknown. Even the dl-GapDurationCoeff is configured up to ½ and T_{Evaluate_}Q_{out_NB-IoT} is configured as 4000 ms, only 1312 ms downlink gap (i.e. └4000/(64+32)┘*32 ms) can be used for intra-frequency neighbor cell measurements and cannot satisfy the cell detection requirement (i.e., at least 1400 ms) when the target cell is unknown and signal quality is bad. Therefore, the dl-GapDurationCoeff may need to be extended to satisfy the cell detection requirement. For example, dl-GapDurationCoeff may be ⅝, 6/8, ⅞, or 1. The UE may perform intra-frequency neighbor cell measurements for a cell during multiple downlink gaps if the measurement can not be finished within a downlink gap duration.

The triggering and stop mechanism for intra-frequency neighbor cell measurements can be similar to the triggering and stop mechanism for inter-frequency neighbor cell measurements.

Note that if enough downlink gap can be configured, it may be used not only for intra-frequency neighbor cell measurements but also inter-frequency neighbor cell measurements.

b. Neighbor Cell Measurements Between Reference Points B and C:

### b.1 Inter-Frequency Neighbor Cell Measurements:

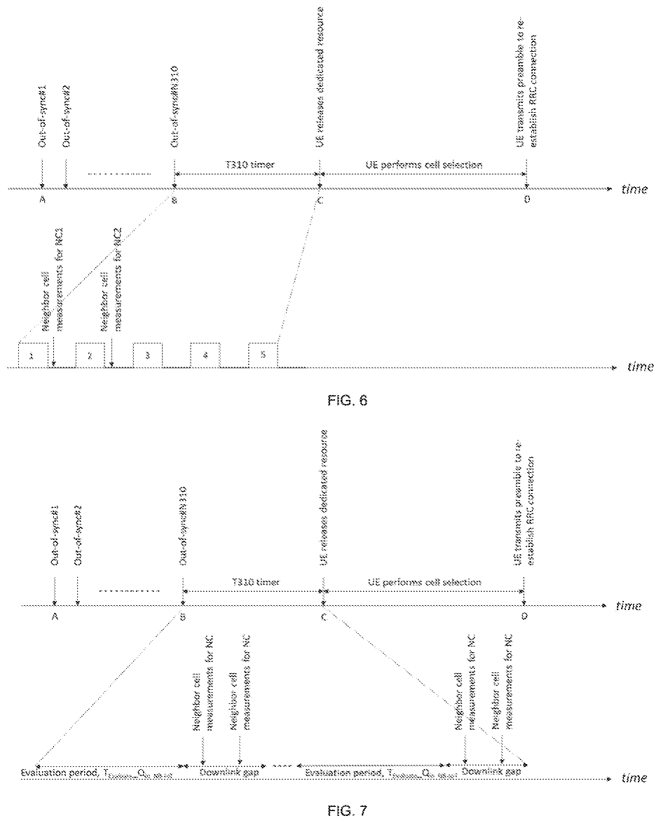

FIG. 6 shows an example of CDRX configuration for inter-frequency neighbor cell measurements between references points B and C. Upon start of T310 timer, the UE shall monitor the link of PCell for recovery using the evaluation period (i.e., T_{Evaluate_}Q_{in_NB-IoT} ms for in-sync evaluation) and Layer 1 indication interval (i.e., T_{Evaluate_}Q_{in_NB-IoT} ms for in-sync indication) until the expiry or stop of T310 timer. NC1 and NC2 respectively represent a first neighbor cell and a second neighbor cell. The link comprise NPDCCH and NPDSCH. The evaluation period, T_{Evaluate_}Q_{in_NB-IoT}, depends on the maximum NPDCCH repetitions, Rₘₐₓ. When Rₘₐₓ is smaller than or equal to 64, T_{Evaluate_}Q_{in_NB-IoT} is equal to 200 ms. Otherwise, T_{Evaluate_}Q_{in_NB-IoT} is equal to 2000 ms. T310 timer is stopped upon reception of N311 consecutive in-sync indications from the lower layer; otherwise T310 timer will continue until expiry. As discussed in section a, the DRX off period provides the opportunities of a receiver downlink gap to perform inter-frequency neighbor cell measurements, and the UE can continue to monitor the link of PCell after changing back to the center frequency of the serving cell.

The triggering mechanism for the inter-frequency neighbor cell measurements may include one or more of a triggering event based on T310 timer, a triggering event based on RSRP/RSRQ of the anchor carrier of the serving cell, and a triggering event based on a network assistance indication:
1 Start of T310 timer: The UE can perform inter-frequency neighbor cell measurements during the DRX off period after T310 timer starts.
2 RSRP/RSRQ of the anchor carrier of the serving cell: When the RSRP/RSRQ measured on the DRX on period is worse than a threshold (referred to as an RSRP/RSRQ threshold or a signal quality threshold), the inter-frequency neighbor cell measurements are started in the off period of the same DRX cycle.
3 Network assistance indication: If at least one of the trigger conditions is sent to the UE in advance, the UE can perform the inter-frequency neighbor cell measurements during the DRX off period when at least one of the trigger conditions are met.

The trigger conditions may include one or more of:
a) a distance between the UE and a satellite that serves or is capable of serving the UE;
b) a timer to time a period according to which the inter-frequency neighbor cell measurements are triggered;
and
c) a timing advance value to the target cell; and
d) an elevation angle of the serving cell (i.e., a source cell) and/or an elevation angle of the target cells.

The stop mechanism for inter-frequency neighbor cell measurements between reference points B and C can be similar to the ones for inter-frequency neighbor cell measurements between reference points A and B.

### b.2 Intra-Frequency Neighbor Cell Measurements:

FIG. 7 shows an example of downlink gap configuration for intra-frequency neighbor cell measurements between references points B and C. Upon start of T310 timer, the UE shall monitor the link of PCell for recovery using the evaluation period and Layer 1 indication interval until the expiry or stop of T310 timer. The UE may perform the intra-frequency neighbor cell measurements during the downlink gap which may be configured as the following. For example, the downlink gap threshold, dl-Threshold, (e.g., the parameter dl-GapThreshold-r13) on the maximum number of repetitions (i.e., Rₘₐₓ) is configured as n32. The dl-GapPeriodicity (e.g., the parameter dl-GapPeriodicity-r13) is configured as 512 subframes, and the dl-GapDurationCoeff (e.g., dl-GapDurationCoeff-r13) is configured as ½ (i.e., oneHalf). When the Rₘₐₓ=64 (i.e., which is larger than the threshold 32), there are 256 subframes (i.e., 512*½) downlink gap duration after 512 ms NPDSCH transmissions. Actually, the downlink gap duration of 256 ms is the maximum downlink gap which can be configured after every 512 ms NPDSH transmission. Considering counting up to the maximum of T310 timer is 8000 ms, total 2560 ms downlink gap can be configured during the T310 timer. The downlink gap duration of 2560 ms may be enough for performing intra-frequency neighbor cell measurements when the target cell is unknown and signal quality is good or bad in normal coverage (i.e., 80 ms/1400 ms). However, the duration may be not enough when the target cell is unknown and signal quality is bad in enhanced coverage.

The triggering and stop mechanism for intra-frequency neighbor cell measurements can be similar to the ones for inter-frequency neighbor cell measurements.

### 2. Procedures for Neighbor Cell Measurements Before RRC Re-Establishment (i.e., Reference Point C):

2.1

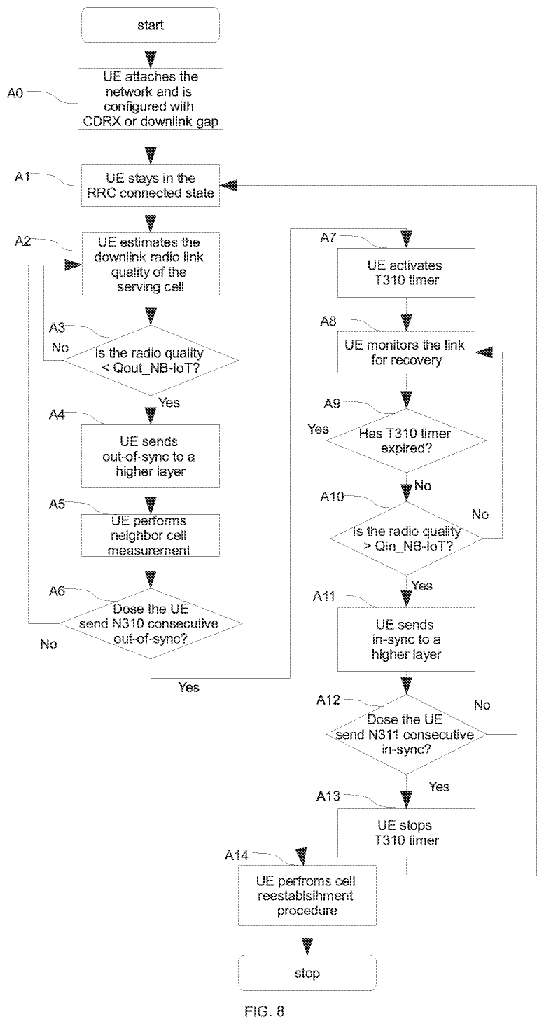

FIG. 8 illustrates a schematic diagram showing an embodiment of inter-frequency/intra-frequency neighbor cell measurements between references points A and B, embodiments of which are detailed in sections 1.a.1 and 1.a.2.

Step A0: The UE (e.g., UE 10) attaches to the network and is configured with an appropriate CDRX configuration through a MAC configuration signaling (e.g., MAC-MainConfig-NB IE) or with a downlink gap configuration through a downlink gap configuration signaling (e.g., DL-GapConfig-NB IE). The MAC-MainConfig-NB IE can be configured by an RRC message, RRCConnectionReconfiguration-NB. The DL-GapConfig-NB IE can be configured by the system information, SystemInformationBlockType2-NB (SIB2-NB).

Step A1: After successfully attaching to the network, the UE enters an RRC connected state.

Step A2: The UE performs serving cell measurements periodically based on the requirements of radio link monitoring. Detailed serving cell measurements and the requirements of radio link monitoring may be referenced to in section 7.23 of TS 36.133.

Step A3: The UE determines whether the radio quality of an anchor carrier of the serving cell is lower than the threshold, Q_{out_NB-IoT}? If the radio quality is lower than Q_{out_NB-IoT}, the UE goes to Step A4. Otherwise, the UE goes back to Step A2 to continue performing measurements.

Step A4: The UE sends out-of-sync indication(s) from a lower layer (i.e., L1 layer or PHY layer) to a higher layer (i.e., RRC layer).

Step A5: Based on the triggering mechanism described in sections 1.a.1 and 1.a.2, the UE may perform inter-frequency/intra-frequency neighbor cell measurements during DRX off periods or downlink gaps. The UE may perform cell-selection-based neighbor cell detection (i.e., to find one suitable cell) or cell-reselection-based neighbor cell detection (i.e., to find multiple suitable cells) depending on the UE implementation. The UE may also receive the system information of the suitable cell(s) such that the re-establishment delay between reference points C and D can be further reduced. For example, when obtaining random access resource(s) from the system information, SystemInformationBlockType2-NB (SIB2-NB), the UE may skip cell selection and system information receiving and perform a random access procedure directly when T310 timer expires.

Step A6: The UE counts the number of consecutive out-of-sync indications and determines whether N310 consecutive out-of-sync indications has been sent to the higher layer (i.e., RRC layer)? If the UE sends N310 consecutive out-of-sync indications to the higher layer (i.e., RRC layer), the UE goes to Step A7. Otherwise, the UE goes back to Step A2 to continue performing measurements. N310 is a positive integer.

Step A7: The UE activates T310 timer.

Step A8: The UE monitors the radio link of serving cell and estimates the downlink radio link quality.

Step A9: The UE checks whether T310 timer expires? If T310 timer expires, the UE releases radio resources, enters the RRC Idle state, and goes to Step A14. Otherwise, the UE goes to Step A10.

Step A10: The UE compares the estimated downlink radio link quality to the thresholds Q_{in_NB-IoT} If the radio link quality is lower than Q_{out_NB-IoT}, the UE goes to Step A8 to continue estimating the downlink radio link quality. Otherwise, the UE goes to Step A11.

Step A11: The UE sends in-sync indication(s) to the higher layer (i.e., RRC layer).

Step A12: The UE counts the number of consecutive in-sync indications and determines whether N311 consecutive out-of-sync indications have been sent to the higher layer (i.e., RRC layer)? If the UE sends N311 consecutive in-sync indications to the higher layer (i.e., RRC layer), the UE goes to Step A13. Otherwise, the UE goes back to Step A8 to continue estimating the downlink radio link quality. N311 is a positive integer.

Step A13: N311 consecutive in-sync indications means that the radio link quality returns to a good level. The UE stops T310 timer and then goes back to Step A1.

Step A14: The UE performs cell re-establishment procedure which includes cell selection and a random access procedure.

2.2

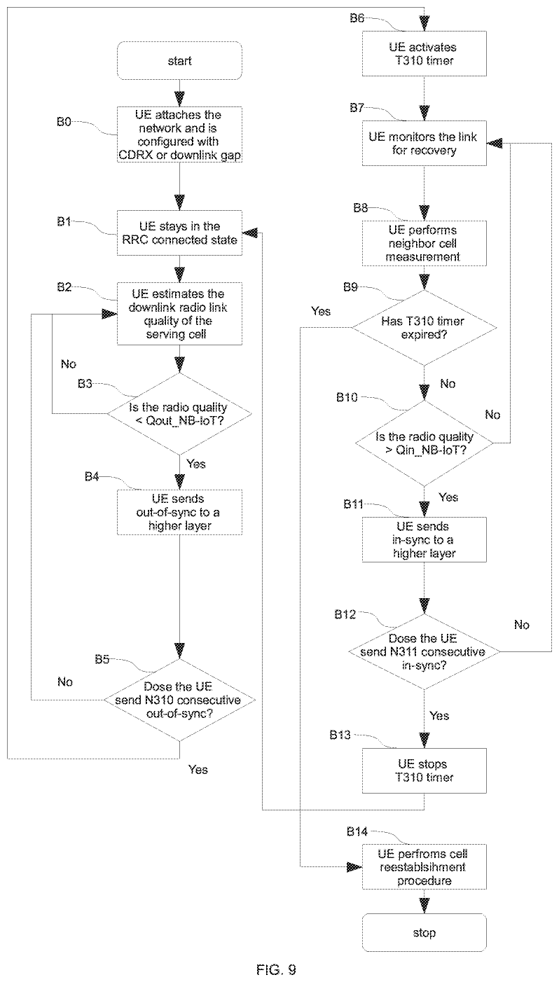

FIG. 9 illustrates a schematic diagram showing an embodiment of inter-frequency/intra-frequency neighbor cell measurements between references points B and C, embodiments of which are detailed in sections 1.b.1 and 1.b.2.

Step B0: The UE (e.g., UE 10) attaches to the network and is configured with an appropriate CDRX configuration through a MAC configuration signaling (e.g., MAC-MainConfig-NB information element) or with a downlink gap configuration through a downlink gap configuration signaling (e.g., DL-GapConfig-NB IE). The MAC-MainConfig-NB IE can be configured by an RRC message, RRCConnectionReconfiguration-NB. The DL-GapConfig-NB IE can be configured by the system information, SystemInformationBlockType2-NB (SIB2-NB).

Step B1: After successfully attaching to the network, the UE enters RRC connected state.

Step B2: The UE performs serving cell measurements periodically based on the requirements of radio link monitoring. Detailed serving cell measurements and the requirements of radio link monitoring may be referenced to in section 7.23 of TS 36.133.

Step B3: The UE determines whether the radio quality of an anchor carrier of the serving cell is lower than the threshold, Q_{out_NB-IoT}? If the radio quality is lower than Q_{out_NB-IoT}, the UE goes to Step B4. Otherwise, the UE goes back to Step B2 to continue performing measurements.

Step B4: The UE sends out-of-sync indication(s) from a lower layer (i.e., L1 layer or PHY layer) to a higher layer (i.e., RRC layer).

Step B5: The UE counts the number of consecutive out-of-sync indications and determines whether N310 consecutive out-of-sync indications have been sent to the higher layer (i.e., RRC layer)? If the UE sends N310 consecutive out-of-sync indications to the higher layer (i.e., RRC layer), the UE goes to Step B6. Otherwise, the UE goes back to Step B2 to continue performing measurements. N310 is a positive integer.

Step B6: The UE activates T310 timer.

Step B7: The UE monitors the radio link of serving cell and estimates the downlink radio link quality.

Step B8: Based on triggering mechanism described in sections 1.b.1 and 1.b.2, the UE may perform inter-frequency/intra-frequency neighbor cell measurements during DRX off periods or downlink gaps. The UE may perform cell-selection-based neighbor cell detection (i.e., to find one suitable cell) or cell-reselection-based neighbor cell detection (i.e., to find multiple suitable cells) depending on the UE implementation. The UE may also receive the system information of the suitable cell(s) such that the re-establishment delay between reference points C and D can be further reduced. For example, when obtaining random access resource(s) from the system information, SystemInformationBlockType2-NB (SIB2-NB), the UE may skip cell selection and system information receiving and perform a random access procedure directly when T310 timer expires.

Step B9: The UE checks whether T310 timer expires? If T310 timer expires, the UE releases radio resources, enters the RRC Idle state, and goes to Step B14. Otherwise, the UE goes to Step B10. Step B10: The UE compares the estimated downlink radio link quality to the thresholds Q_{in_NB-IoT} If the radio link quality is lower than Q_{in_NB-IoT}, the UE goes to Step B7 to continue estimating the downlink radio link quality. Otherwise, the UE goes to Step B11.

Step B11: The UE sends in-sync indication(s) to the higher layer (i.e., RRC layer).

Step B12: The UE counts the number of consecutive in-sync indications and determines whether N311 consecutive out-of-sync indications have been sent to the higher layer (i.e., RRC layer)? If the UE sends N311 consecutive in-sync indications to the higher layer (i.e., RRC layer), the UE goes to Step B13. Otherwise, the UE goes back to Step B8 to continue estimating the downlink radio link quality.

Step B13: N311 consecutive in-sync indications means that the radio link quality returns to a good level. The UE stops T310 timer and then goes back to Step B1.

Step B14: The UE performs cell re-establishment procedure which includes cell selection and a random access procedure.

Note that when the time between reference points A and B is not sufficient for performing neighbor cell measurements, combination of embodiments in sections 2.1 and 2.2 can be adopted to provide enough time for neighbor cell measurements.

2.3

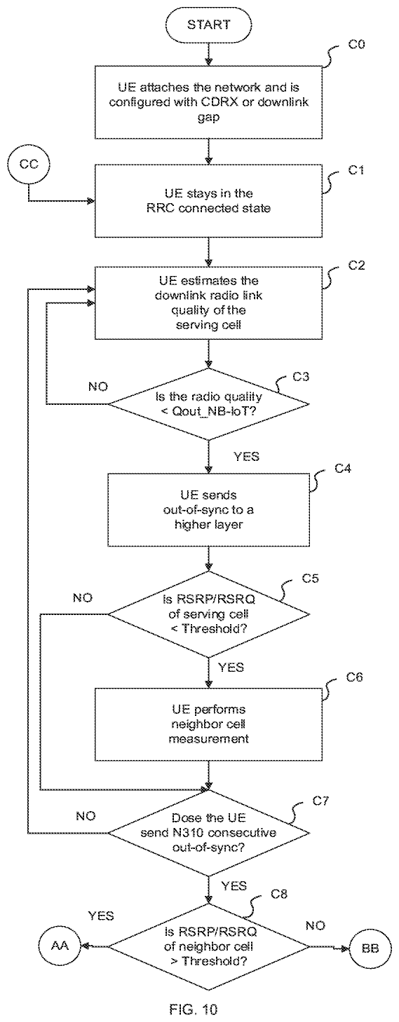

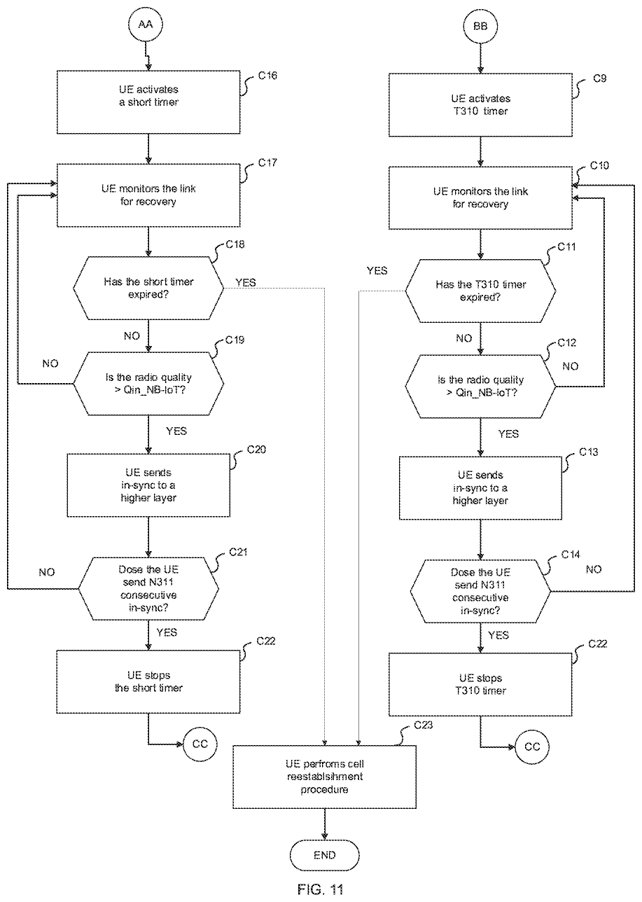

FIG. 10 and FIG. 11 illustrates a schematic diagram showing an embodiment of the disclosed method with a short timer to reduce link recovery time between reference points B and C. In the embodiment, the inter-frequency/intra-frequency measurements are triggered by the estimated RSRP/RSRQ of the serving cell. If the radio quality (e.g., RSRP/RSRQ) of the serving cell is lower than a threshold (e.g., a threshold for serving cell, denoted as T_{SC}) and the radio quality of the neighbor cell is higher than a threshold (e.g., a threshold for neighbor cell, denoted as T Nc), the situation shows that the UE (e.g., UE 10) is away from the serving cell and closer to the neighbor cell. The UE does not need to wait for the end of T310 timer. A short timer (denoted as Tₛₕₒᵣₜ) which is shorter than T310 timer can be used to terminate the radio recovery as soon as possible. Definition of the short timer is the same as the T310 timer except that a duration timed by the short timer is shorter than a duration timed by the T310 timer.

Step C0: The UE (e.g., UE 10) attaches to the network and is configured with an appropriate CDRX configuration through a MAC configuration signaling (e.g., MAC-MainConfig-NB information element) or with a downlink gap configuration through a downlink gap configuration signaling (e.g., DL-GapConfig-NB IE). The MAC-MainConfig-NB IE can be configured by an RRC message, RRCConnectionReconfiguration-NB. The DL-GapConfig-NB IE can be configured by the system information, SystemInformationBlockType2-NB (SIB2-NB).

Step C1: After successfully attaching to the network, the UE enters RRC connected state.

Step C2: The UE performs serving cell measurements periodically based on the requirements of radio link monitoring. Detailed serving cell measurements and the requirements of radio link monitoring may be referenced to in section 7.23 of TS 36.133.

Step C3: The UE determines whether the radio quality of an anchor carrier of the serving cell is lower than the threshold, Q_{out_NB-IoT}? If the radio quality is lower than Q_{out_NB-IoT}, the UE goes to Step C4. Otherwise, the UE goes back to Step C2 to continue performing measurements.

Step C4: The UE sends out-of-sync indication(s) from a lower layer (i.e., L1 layer or PHY layer) to a higher layer (i.e., RRC layer).

Step C5: The UE determines whether the measured RSRP/RSRQ of the serving cell is lower than a threshold, T_{SC}? If the RSRP/RSRQ of the serving cell is lower than T_{SC}, the UE goes to Step C6 to trigger neighbor cell measurements. Otherwise, the UE bypass Step C6 and goes to Step C7.

Note that The threshold T_{SC} may be configured for the UE in the RRC connected state. To early trigger the inter-frequency/intra-frequency neighbor cell measurements, a value of T_{SC} (i.e., compared with the threshold for RRC idle state) for the UE in the RRC connected state may be configured lower than the threshold for the UE in the RRC idle state.

Step C6: Based on the estimated RSRP/RSRQ of the serving cell described in section 1.a.1 and 1.a.2, the UE may perform inter-frequency/intra-frequency neighbor cell measurements during DRX off periods or downlink gaps. The UE may perform cell-selection-based neighbor cell detection (i.e., to find one suitable cell) or cell-reselection-based neighbor cell detection (i.e., to find multiple suitable cells) depending on the UE implementation. The UE may also receive the system information of the suitable cell(s) such that the re-establishment delay between reference points C and D can be further reduced. For example, when obtaining random access resource(s) from the system information, SystemInformationBlockType2-NB (SIB2-NB), the UE may skip cell selection and system information receiving and perform a random access procedure directly when T310 timer expires.

Step C7: The UE counts the number of consecutive out-of-sync indications and determines whether N310 consecutive out-of-sync indications have been sent to the higher layer (i.e., RRC layer)? If the UE sends N310 consecutive out-of-sync indications to the higher layer (i.e., RRC layer), the UE goes to Step C8. Otherwise, the UE goes back to Step C2 to continue performing measurements. N310 is a positive integer.

Step C8: The UE determines whether RSRP/RSRQ of the neighbor cell is higher than a threshold, T_{NC}? If the RSRP/RSRQ of the neighbor cell is higher than the threshold T_{NC}, the UE goes to Step C16 to activate a short timer, Tₛₕₒᵣₜ. Otherwise, the UE goes to Step C9 to activate T310 timer.

Step C9: The UE activates T310 timer.

Step C10: The UE monitors the radio link of serving cell and estimates the downlink radio link quality.

Step C11: The UE checks whether T310 timer expires? If T310 timer expires, the UE releases radio resources, enters the RRC Idle state, and goes to Step C23. Otherwise, the UE goes to Step C12.

Step C12: The UE compares the estimated downlink radio link quality to the thresholds Q_{in_NB-IoT}. If the radio link quality is lower than Q_{in_NB-IoT}, the UE goes to Step C10 to continue estimating the downlink radio link quality. Otherwise, the UE goes to Step C13.

Step C13: The UE sends in-sync indication(s) to the higher layer (i.e., RRC layer).

Step C14: The UE counts the number of consecutive in-sync indications and determines whether N311 consecutive out-of-sync indications have been sent to the higher layer (i.e., RRC layer)? If the UE sends N311 consecutive in-sync indications to the higher layer (i.e., RRC layer), the UE goes to Step C15. Otherwise, the UE goes back to Step 010 to continue estimating the downlink radio link quality.

Step C15: N311 consecutive in-sync indications means that the radio link quality returns to a good level. The UE stops T310 timer and then goes back to Step C1.

Step C16: The UE activates a short timer, Tₛₕₒᵣₜ.

Step C17: The UE monitors the radio link of serving cell and estimates the downlink radio link quality.

Step C18: The UE checks whether Tₛₕₒᵣₜ timer is expired? If Tₛₕₒᵣₜ timer is expired, the UE releases radio resources, enters the RRC Idle state, and goes to Step C23. Otherwise, the UE goes to Step C19.

Step C19: The UE compares the estimated downlink radio link quality to the thresholds Q_{in_NB-IoT}. If the radio link quality is lower than Q_{in_NB-IoT}, the UE goes to Step C17 to continue estimating the downlink radio link quality. Otherwise, the UE goes to Step C20.

Step C20: The UE sends in-sync to higher layer (i.e., RRC layer).

Step C21: The UE counts the number of consecutive in-sync indications and determines whether N311 consecutive out-of-sync indications have been sent to higher layer (i.e., RRC layer)? If the UE sends N311 consecutive in-sync indications to higher layer (i.e., RRC layer), the UE goes to Step C22. Otherwise, the UE goes back to Step C17 to continue estimating the downlink radio link quality.

Step C22: N311 consecutive in-sync indications means that the radio link quality returns to a good level. The UE stops Tₛₕₒᵣₜ timer and then goes back to Step C1.

Step C23: The UE performs cell re-establishment procedure which includes cell selection and a random access procedure.

In the embodiment, the UE 10 determines whether signal quality of the reference signals in the narrowband downlink channel in the one or more neighbor cells is higher than a signal quality threshold. The UE 10 activates a short timer when the signal quality of the reference signals in the narrowband downlink channel in the one or more neighbor cells is higher than the signal quality threshold. The UE 10 activates a T310 timer when the signal quality of the reference signals in the narrowband downlink channel in the one or more neighbor cells is not higher than the signal quality threshold. Definition of the short timer is the same as the T310 timer except that a duration timed by the short timer is shorter than a duration timed by the T310 timer.

2.4

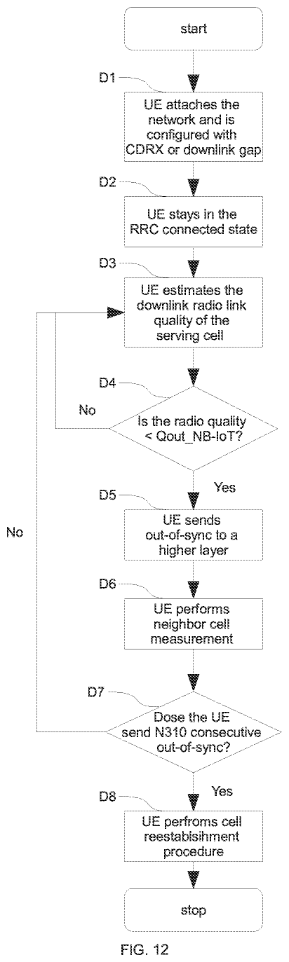

FIG. 12 illustrates a schematic diagram showing an embodiment of the disclosed method where the timer (e.g., T310 timer) for radio link recovery is not used. The UE 10 is moving in RRC connected mode without radio link recovery. For the application such as IoT over NTN, when the serving cell is moving away, cell re-establishment to the next cell (or satellite) can be expected and there is no possibility of keeping connection with the serving cell. Therefore, radio link recovery (i.e., between reference points B and C) can be omitted and the UE should directly perform cell re-establishment with the target cell. To improve the efficiency of neighbor cell measurements, the serving cell can provide the information of the next cell(s) (e.g., cell identifier(s) of the cell(s) on the orbit) such that the UE can measure the potential cell(s) without blind search. The next cell represents a satellite and can be processed as a neighbor cell in the embodiments of the disclosure.

Step D0: The UE (e.g., UE 10) attaches to the network and is configured with an appropriate CDRX configuration through a MAC configuration signaling (e.g., MAC-MainConfig-NB information element) or with a downlink gap configuration through a downlink gap configuration signaling (e.g., DL-GapConfig-NB IE). The MAC-MainConfig-NB IE can be configured by an RRC message, RRCConnectionReconfiguration-NB. The DL-GapConfig-NB IE can be configured by the system information, SystemInformationBlockType2-NB (SIB2-NB). The network may provide network assistance indication comprising the information of the next cell(s) to help the UE performing neighbor cell measurements. The information may include cell identity, frequency band number, or E-UTRA Absolute Radio Frequency Channel Number (EARFCN), etc.

Step D1: After successfully attaching to the network, the UE enters RRC connected state.

Step D2: The UE performs serving cell measurements periodically based on the requirements of radio link monitoring. Detailed serving cell measurements and the requirements of radio link monitoring may be referenced to in section 7.23 of TS 36.133.

Step D3: The UE determines whether the radio quality of an anchor carrier of the serving cell is lower than the threshold, Q_{out_NB-IoT}? If the radio quality is lower than Q_{out_NB-IoT}, the UE goes to Step D4. Otherwise, the UE goes back to Step D2 to continue performing measurements.

Step D4: The UE sends out-of-sync indication(s) from a lower layer (i.e., L1 layer or PHY layer) to a higher layer (i.e., RRC layer).

Step D5: Based on triggering mechanism described in section 1.a.1 and 1.a.2, the UE may perform inter-frequency/intra-frequency neighbor cell measurements during DRX off periods or downlink gaps. The UE may should perform cell-selection-based neighbor cell detection (i.e., because the UE is covered by only one satellite). The UE may also receive the system information of the target cell such that the re-establishment delay between reference points C and D can be further reduced. For example, when obtaining random access resource(s) from the system information, SystemInformationBlockType2-NB (SIB2-NB), the UE may skip cell selection and system information receiving and perform a random access procedure directly when N310 consecutive out-of-sync indications are sent.

Step D6: The UE counts the number of consecutive out-of-sync indications and determines whether N310 consecutive out-of-sync indications have been sent to the higher layer (i.e., RRC layer)? If the UE sends N310 consecutive out-of-sync indications to the higher layer (i.e., RRC layer), the UE goes to Step D7. Otherwise, the UE goes back to Step D2 to continue performing measurements. N310 is a positive integer.

Step D7: The UE performs cell re-establishment procedure which includes cell selection and a random access procedure.

2.5

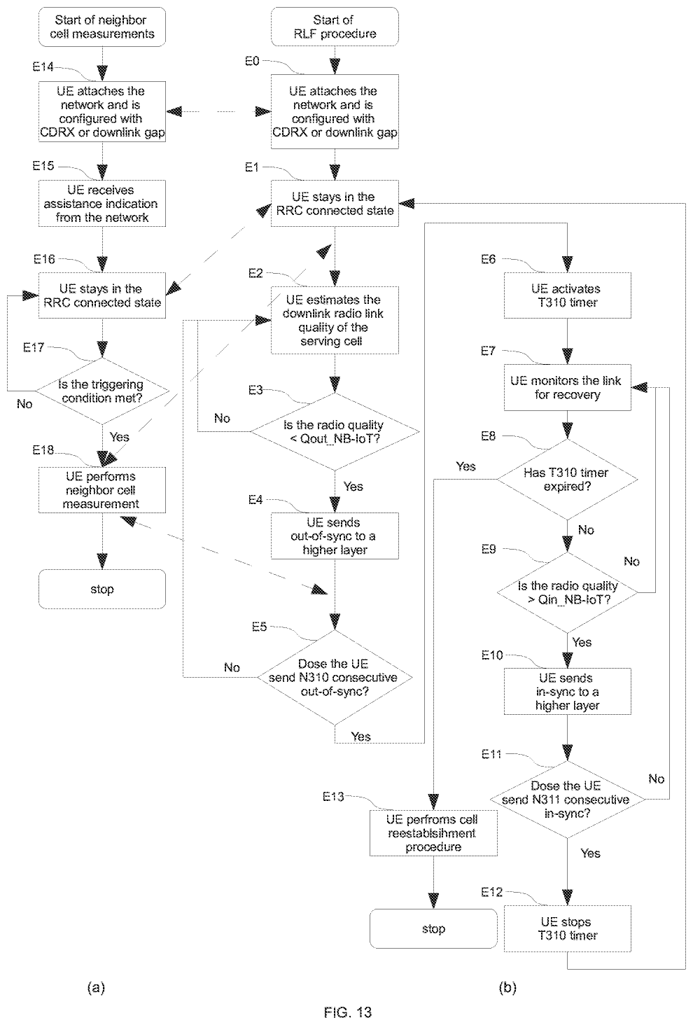

FIG. 13 illustrates a schematic diagram showing an embodiment of the procedure of neighbor cell measurements independent of the procedure of RLF and RRC re-establishment. This embodiment is especially suitable for the application of IoT over NTN. In addition to the RSRP/RSRQ of the serving cell, the neighbor cell measurements may be triggered by the network using assistance information. The assistance information may include:
a) a distance between the UE and the serving cell or a distance between the UE and the target cell;
b) a timer to time a period according to which the inter-frequency neighbor cell measurements are triggered;
c) a timing advance value to the serving cell and/or target cell, and
d) an elevation angle of the serving cell (i.e., a source cell) and/or an elevation angle of the target cells.

The RLF will be accompanied when the above conditions are triggered, and therefore neighbor cell measurements can be performed before RLF declares (i.e., T310 timer is activated).

FIG. 13 (a) illustrates a schematic diagram showing a flow chart of neighbor cell measurements triggering by network assistance information. FIG. 13 (b) illustrates a schematic diagram showing a flow chart of RLF and RRC re-establishment procedures.

Step E0: The UE (e.g., UE 10) attaches to the network and is configured with an appropriate CDRX configuration through a MAC configuration signaling (e.g., MAC-MainConfig-NB information element) or with a downlink gap configuration through a downlink gap configuration signaling (e.g., DL-GapConfig-NB IE). The MAC-MainConfig-NB IE can be configured by an RRC message, RRCConnectionReconfiguration-NB. The DL-GapConfig-NB IE can be configured by the system information, SystemInformationBlockType2-NB (SIB2-NB).

Step E1: After successfully attaching to the network, the UE enters RRC connected state.

Step E2: The UE performs serving cell measurements periodically based on the requirements of radio link monitoring. Detailed serving cell measurements and the requirements of radio link monitoring may be referenced to in section 7.23 of TS 36.133.

Step E3: The UE determines whether the radio quality of an anchor carrier of the serving cell is lower than the threshold, Q_{out_NB-IoT}? If the radio quality is lower than Q_{out_NB-IoT}, the UE goes to Step E4. Otherwise, the UE goes back to Step E2 to continue performing measurements.

Step E4: The UE sends out-of-sync indication(s) from a lower layer (i.e., L1 layer or PHY layer) to a higher layer (i.e., RRC layer).

Step E5: The UE counts the number of consecutive out-of-sync indications and determines whether N310 consecutive out-of-sync indications have been sent to the higher layer (i.e., RRC layer)? If the UE sends N310 consecutive out-of-sync indications to the higher layer (i.e., RRC layer), the UE goes to Step E6. Otherwise, the UE goes back to Step E2 to continue performing measurements. N310 is a positive integer.

Step E6: The UE activates T310 timer.

Step E7: The UE monitors the radio link of serving cell and estimates the downlink radio link quality.

Step E8: The UE checks whether T310 timer expires? If T310 timer expires, the UE releases radio resources, enters the RRC Idle state, and goes to Step E13. Otherwise, the UE goes to Step E9.

Step E9: The UE compares the estimated downlink radio link quality to the thresholds Q_{in_NB-IoT}. If the radio link quality is lower than Q_{in_NB-IoT}, the UE goes to Step E7 to continue estimating the downlink radio link quality. Otherwise, the UE goes to Step E10.

Step E10: The UE sends in-sync indication(s) to the higher layer (i.e., RRC layer).

Step E11: The UE counts the number of consecutive in-sync indications and determines whether N311 consecutive out-of-sync indications have been sent to the higher layer (i.e., RRC layer)? If the UE sends N311 consecutive in-sync indications to the higher layer (i.e., RRC layer), the UE goes to Step E12. Otherwise, the UE goes back to Step E7 to continue estimating the downlink radio link quality. N311 is a positive integer.

Step E12: N311 consecutive in-sync indications means that the radio link quality returns to a good level. The UE stops T310 timer and then goes back to Step E1.

Step E13: The UE performs cell re-establishment procedure which includes cell selection and a random access procedure.

Step E14: This Step is in parallel to Step E0. In Step E14, The UE attaches to the network and is configured with an appropriate CDRX configuration through a MAC configuration signaling (e.g., MAC-MainConfig-NB information element) or with a downlink gap configuration through a downlink gap configuration signaling (e.g., DL-GapConfig-NB IE).

Step E15: The UE receives network assistance indication from the network. For example, in the application of IoT over NTN, the network has the information about when the serving cell will leave and when the next target will arrive. Therefore, the network may configure the UE with a timer, and the UE triggers neighbor cell measurements when the timer counts down to zero. The network may provide constellation ephemeris information of the target cell to the UE to measure the position of the target cell and the distance/elevation angles between the UE and the target cell. The UE can uses the measurements to trigger the neighbor cell measurements.

Step E16: This Step is parallel to Step E1. In step E16, after successfully attaching to the network, the UE enters RRC connected state.

Step E17: The UE determines whether at least one of the trigger conditions is met? If at least one of the trigger conditions is met, the UE goes to Step E18. Otherwise, the UE goes back to Step E16.

Step E18: The UE may perform inter-frequency/intra-frequency neighbor cell measurements during DRX off periods or downlink gap. The UE may perform cell-selection-based neighbor cell detection (i.e., to find one suitable cell) or cell-reselection-based neighbor cell detection (i.e., to find multiple suitable cells) depending on the UE implementation. The UE may also receive the system information of the suitable cell(s) such that the re-establishment delay between reference points C and D can be further reduced. For example, when obtaining random access resource(s) from the system information, SystemInformationBlockType2-NB (SIB2-NB), the UE may skip cell selection and system information receiving and perform a random access procedure directly when T310 timer expires. Comparing with the RLF procedure in FIG. 13 (b), this step E18 may be performed before out-of-sync happens (i.e., before Step E2) or after out-of-sync happens (i.e., after Step E4).

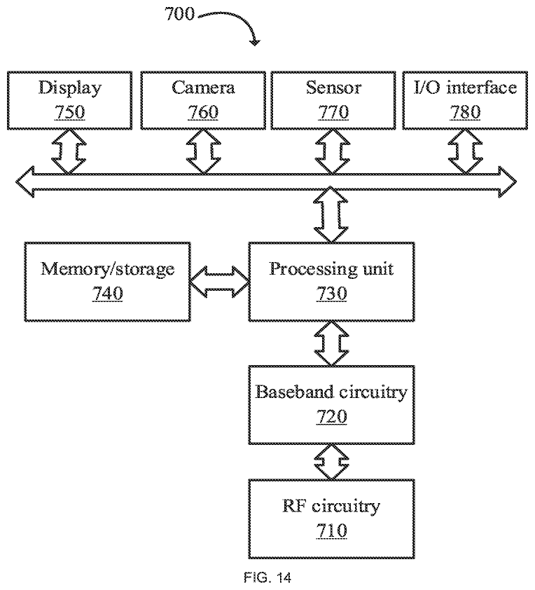

FIG. 14 is a block diagram of an example system 700 for wireless communication according to an embodiment of the present disclosure. Embodiments described herein may be implemented into the system using any suitably configured hardware and/or software. FIG. 14 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an Ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A cell measurement method executable in a user equipment (UE), comprising:
evaluating signal quality of reference signals in a narrowband downlink channel in a serving cell;
detecting at least one of a plurality triggering events for neighbor cell measurements associated with the evaluating of the signal quality of the reference signals in the narrowband downlink channel in the serving cell;
performing neighbor cell measurements on reference signals in a narrowband downlink channel in one or more neighbor cells in a cell measurement period in response to the at least one of a plurality triggering events, wherein the neighbor cell measurements are performed before radio link failure (RLF) associated with the user equipment;
selecting at least one target cell among the one or more neighbor cells through the neighbor cell measurements in the narrowband downlink channel in one or more neighbor cells; and
performing a cell reestablishment procedure with the at least one target cell when a condition for the cell reestablishment procedure is met.

2. The method of claim 1, wherein the signal quality of the reference signals in the narrowband downlink channel in the serving cell is measured based on reference signal received power (RSRP) or reference signal received quality (RSRQ).

3. The method of claim 1, wherein the narrowband downlink channel in the serving cell comprises narrowband physical downlink shared channel (NPDSCH), narrowband physical downlink control channel (NPDCCH), primary/secondary synchronization signal, or reference signals for radio link monitoring.

4. The method of claim 1, wherein the narrowband downlink channel in the one or more neighbor cells comprises narrowband physical downlink shared channel (NPDSCH), narrowband physical downlink control channel (NPDCCH), primary/secondary synchronization signal, or reference signals for radio link monitoring.

5. The method of claim 1, wherein the cell measurement period comprises one or more of:
a connected mode discontinuous reception (CDRX) off period; or
a downlink gap.

6. The method of claim 1, wherein the at least one of a plurality triggering events comprises:
a condition that at least one out-of-sync indication is received from a physical layer of the UE.

7. The method of claim 1, wherein the at least one of a plurality triggering events comprises:
a condition that the signal quality of the reference signals in the narrowband downlink channel in the serving cell is lower than a signal quality threshold.

8. The method of claim 7, wherein the signal quality threshold is configured by a broadcast message SystemInformationBlockType3-NB, a unicast message RRCConnectionReconfiguration-NB, or a unicast message RRCConnectionResume-NB.

9. The method of claim 7, wherein the signal quality threshold comprises a signal quality threshold for inter-frequency neighbor cell measurements in RRC connected state and a signal quality threshold for inter-frequency neighbor cell measurements in RRC idle state; and
the signal quality threshold for inter-frequency neighbor cell measurements in RRC connected state is different from the signal quality threshold for inter-frequency neighbor cell measurements in RRC idle state.

10. The method of claim 7, wherein the signal quality threshold comprises a signal quality threshold for a stationary user equipment and a signal quality threshold for a moving user equipment; and
the signal quality threshold for a moving user equipment is different from the signal quality threshold for a stationary user equipment.

11. The method of claim 1, wherein the at least one of a plurality triggering events comprises:
receiving a network assistance indication comprising trigger conditions used for the neighbor cell measurements.

12. The method of claim 11, wherein the trigger conditions include one or more of:
a distance between the user equipment and the serving cell or a distance between the UE and the at least one target cell;
a distance between the user equipment and a satellite that serves or is capable of serving the user equipment;
a timer to time a period according to which the neighbor cell measurements are triggered;
a timing advance value to the at least one target cell;
an elevation angle of the serving cell; or
an elevation angle of the at least one target cell.

13. The method of claim 11, wherein the network assistance indication includes information of the one or more neighbor cells;
the information includes one or more of a cell identity, a frequency band number, and an evolved universal mobile telecommunication system territorial radio access (E-UTRA) absolute radio frequency channel number (EARFCN).

14. The method of claim 1, wherein the neighbor cell measurements comprise intra-frequency neighbor cell measurements or inter-frequency neighbor cell measurements.

15. The method of claim 1, wherein the user equipment avoids performing neighbor cell measurements in radio resource control (RRC) connected state when the user equipment determines that it is stationary.

16. The method of claim 1, wherein the user equipment performs neighbor cell measurements in radio resource control (RRC) connected state when the user equipment determines that the user equipment is moving.

17. The method of claim 1, wherein the neighbor cell measurements are performed before receiving an out-of-sync indication from a physical layer of the UE.

18. The method of claim 1, wherein the neighbor cell measurements are performed after receiving an out-of-sync indication from a physical layer of the UE and before a T310 timer starts.

19. The method of claim 1, wherein the neighbor cell measurements are performed after a T310 timer starts and before expiry of the T310 timer.

20. The method of claim 1, wherein the condition for cell reestablishment procedure with the at least one target cell comprises expiry of a T310 timer; and
the cell reestablishment procedure with the at least one target cell is performed in response to expiry of the T310 timer.

21. The method of claim 1, further comprising:
determining whether signal quality of the reference signals in the narrowband downlink channel in the one or more neighbor cells is higher than a signal quality threshold;
activating a short timer when the signal quality of the reference signals in the narrowband downlink channel in the one or more neighbor cells is higher than the signal quality threshold; and
activating a T310 timer when the signal quality of the reference signals in the narrowband downlink channel in the one or more neighbor cells is not higher than the signal quality threshold;
wherein definition of the short timer is the same as the T310 timer except that a duration timed by the short timer is shorter than a duration timed by the T310 timer.

22. A user equipment (UE) comprising:
a processor configured to call and run a computer program stored in a memory, to cause a device in which the processor is installed to execute a method of claim 1.

23. A chip, comprising:
a processor, configured to call and run a computer program stored in a memory, to cause a device in which the chip is installed to execute a method of claim 1.

24. A computer-readable storage medium, in which a computer program is stored, wherein the computer program causes a computer to execute a method of claim 1.

25.-26. (canceled)
